(19) United States
(12) Patent Application Publication
(10) Pub. No.: US 2020/0077053 A1
(43) Pub. Date: Mar. 5, 2020

(54) CLOSED CIRCUIT TELEVISION SYSTEM, ASSOCIATED POWER SUPPLY CIRCUIT AND METHOD THEREOF

(71) Applicant: Richard Steeley, Round Rock, TX (US)

(72) Inventor: Richard Steeley, Round Rock, TX (US)

(21) Appl. No.: 16/453,806

(22) Filed: Jun. 26, 2019

Related U.S. Application Data
(60) Provisional application No. 62/726,676, filed on Sep. 4, 2018.

(51) Int. Cl. H04N 7/18; G08B 13/196; H04N 5/77; H02M 7/219

(52) U.S. Cl. CPC H04N 7/185; G08B 13/19663; H02M 7/219; H04N 5/772; G08B 13/19617

(57) ABSTRACT

A closed circuit television (CCTV) system includes a camera, a recorder, and a power supply circuit. The camera is arranged to capture an image. The recorder is arranged to receive the image from the camera and store the image. The power supply circuit includes a transforming circuit, a first output port coupled to the camera, a second output port coupled to the recorder, and a voltage source. The transforming circuit is arranged to generate a direct current (DC) voltage by converting an alternating current (AC) voltage. The voltage source is arranged to be selectively charged by the DC voltage, and selectively provide a first DC current to the camera via the first output port and a second DC current to the recorder via the second output port.

### BACKGROUND

Currently, there is no uninterruptible power supply (UPS) designed for a closed circuit television (CCTV) system. Without a UPS, security camera systems are disabled by disruptions to the power supply, whether intentionally caused or during a general power failure. During such a disruption to the power supply, a security camera system will not function, and thereby will not broadcast the visual image of the location that is being secured by the camera. Similarly, any associated video recorder that receives and stores input from a security camera will not be able to receive and record the video signal without power. Therefore, having an uninterruptible power supply is desirable for a CCTV system, particularly when used for security purposes.

### SUMMARY OF THE INVENTION

To meet the need described above, one of the objectives of the present disclosure is to provide a display panel, an associated display system applying the display panel, and an associated method to solve the aforementioned problems.

According to an embodiment of the present disclosure, a closed circuit television (CCTV) system is disclosed. The CCTV system includes a camera, a recorder, and a power supply circuit. The camera is arranged to capture an image. The recorder is arranged to receive the image from the camera and store the image. The power supply circuit includes a transforming circuit, a first output port coupled to the camera, a second output port coupled to the recorder, and a voltage source. The transforming circuit is arranged to generate a direct current (DC) voltage by converting an alternating current (AC) voltage. The voltage source is arranged to be selectively charged by the DC voltage, and to selectively provide a first DC current to the camera via the first output port and a second DC current to the recorder via the second output port.

According to an embodiment of the present disclosure, a power supply circuit of a closed circuit television (CCTV) system is disclosed. The CCTV system includes a camera and a recorder, wherein the camera is arranged to capture an image and the recorder is arranged to receive the image from the camera and store the image. The power supply circuit includes a transforming circuit, a first output port coupled to the camera, a second output port coupled to the recorder, and a voltage source. The transforming circuit is arranged to generate a DC voltage by converting an AC voltage. The voltage source is arranged to be selectively charged by the DC voltage, and to selectively provide a first DC current to the camera via the first output port and a second DC current to the recorder via the second output port.

One embodiment of the present disclosure discloses a power supply method of a closed circuit television (CCTV) system, wherein the CCTV system includes a camera and a recorder, and the camera is arranged to capture an image and the recorder is arranged to receive the image from the camera and store the image. The method includes: selectively discharging a battery of the CCTV system to provide a first DC current to the camera and a second DC current to the recorder when a power supply from the electrical power grid provided to the CCTV system fails.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a diagram illustrating a closed circuit television system according an embodiment of the present disclosure.

FIG. 2 is a diagram illustrating a transforming circuit according to an embodiment of the present disclosure.

FIG. 3 is a diagram illustrating an input filter circuit according to an embodiment of the present disclosure.

FIG. 4 is a diagram illustrating a detailed structure of the input rectifying circuit 210 according to an embodiment of the present disclosure.

FIG. 5 is a diagram illustrating a control circuit according to an embodiment of the present disclosure.

FIG. 6 is a diagram illustrating the structure of output ports according to an embodiment of the present disclosure.

FIG. 7 is a flowchart illustrating a power supply method of a CCTV system according to an embodiment of the present disclosure.

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

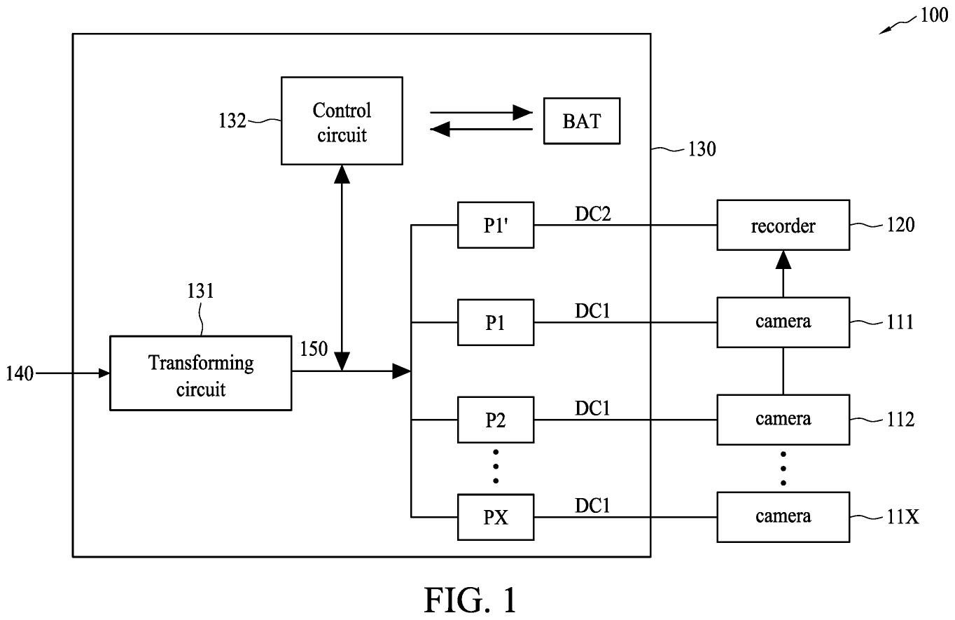

FIG. 1 is a diagram illustrating a closed circuit television circuit (CCTV) system 100 according to an embodiment of the present disclosure. The CCTV system 100 includes a plurality of cameras 111 to 11X, a recorder 120 and a power supply circuit 130. Each of the plurality of cameras 111 to 11X is arranged to capture images of a monitored area, wherein X is a natural number. In this disclosure, each of the cameras 111 to 11X can be a CVBS (Composite Video Broadcast Signal) camera, a HD-TVI (High Definition Transport Video Interface) camera, a HD-CVI (High Definition Composite Video Interface) camera, a HD-AHD (High Definition Analog High Definition) camera, an HD-SDI (High Definition-Serial Digital Interface) camera, a TVI (Transport Video Interface) camera, a AHD (Analog High Definition) camera, or a SDI (Serial Digital Interface) camera, or other security cameras currently known in the art. In other embodiments, each of the cameras 111 to 11X can be an IP/POE camera. It should be noted that the type of the camera 111 to 11X is not a limitation of the present disclosure. The recorder 120 is arranged to store the image information captured by the cameras 111 to 11X. In some embodiments, a coaxial cable such like RG-59 is used to connect between each of the cameras 111 to 11X and the recorder 120, and two conductor cables are used to connect between each of the cameras 111 to 11X and the power supply circuit 130.

In some embodiments, a network cable such like a cat 5 cable or a cat 6 cable is used to connect between each of the cameras 111 to 11X and the recorder 120. In some embodiments, the cameras 111 to 11X utilize wireless technologies to transmit data to the recorder 120. However, the type of the connections between the cameras 111 to 11X and the recorder 120 are only for illustrative purpose, and it should not be limited by the present disclosure.

The power supply circuit 130 includes a transforming circuit 131, a control circuit 132, a battery BAT, an output port P1′ corresponding to the recorder, and a plurality of output ports P1 to PX corresponding to the plurality of cameras 111 to 11X. The transforming circuit 131 is arranged to generate a direct current (DC) voltage 150 by converting an alternating current (AC) voltage 140. Each of the output ports P1 to PX is arranged to receive the DC voltage 150 and output a DC current DC1 to one of the plurality of cameras 111 to 11X, to enable continuing operation of the camera. The output port P1′ is arranged to receive the DC voltage 150 and output a DC current DC2 to the recorder 120.

In one embodiment, X is 8, that is, the CCTV system 100 includes 8 cameras. The DC voltage 150 is 13.8 V. The DC current DC1 is 1.25 amperes (A) while the DC current DC2 is 5 A. In another embodiment, X is 4, that is, the CCTV system 100 includes 4 cameras. The DC voltage 150 is 13.8 V. The DC current DC1 is 1.25 A while the DC current DC2 is 5 A. In yet another embodiment, X is 16, that is, the CCTV system 100 includes 16 cameras. The DC voltage 150 is 13.8 V. The DC current DC1 is 1.56 A while the DC current DC2 is 5 A. However, such examples are presented for illustrative purposes only, and the disclosure should not be limited by the embodiments.

The control circuit 132 is arranged to selectively charge the battery BAT with the DC voltage 150, and to selectively discharge the battery BAT to provide a DC current DC1 to each of the plurality of cameras 111 to 11X via the output ports P1 to PX, respectively, and a DC current DC2 to the recorder 120 via the second output port P1′. More specifically, when the electrical power grid provides the normal AC voltage 140, the transforming circuit 131 generates the DC voltage 150 by converting the AC voltage 140. The DC voltage 150 is received by the output ports P1 to PX and the output port P1′, and is further received by the control circuit 132. The output port P1′ outputs the DC current DC2 to the recorder 120 accordingly to enable continuing operation of the recorder. The output ports P1 to PX output the DC current DC1 to the cameras 111 to 11X, respectively, to enable continuing operation of the cameras. The control circuit 132 charges the battery BAT with the DC voltage when the voltage level of the DC voltage 150 is greater than the voltage level of the battery BAT.

When the electrical power grid fails, for example, when a blackout occurs, the control circuit 132 discharges the battery BAT to provide the DC voltage 150 to enable the continuing operation of the cameras 111 to 11X and the recorder 120. However, when the voltage level of the battery BAT is lower than a predetermined value, the control circuit 132 stops discharging the battery BAT to protect the battery BAT. In one embodiment, the predetermined value is 10.5 volts. With the control circuit 132 and the battery BAT proposed by the present disclosure, the cameras 111 to 11X and the recorder 120 can still maintain continuing operation during a power failure.

It should be noted that the battery BAT is not limited to be integrated in a circuit board with the transforming circuit 131 and the control circuit 132. In other embodiments, the battery BAT may be located outside the power supply circuit 130. Likewise, the output port P1′ and the output ports P1 to PX are not limited to be integrated in a circuit board with the transforming circuit 131 and the control circuit 132. In other embodiments, the output port P1′ and the output ports P1 to PX may be located outside the power supply circuit 130.

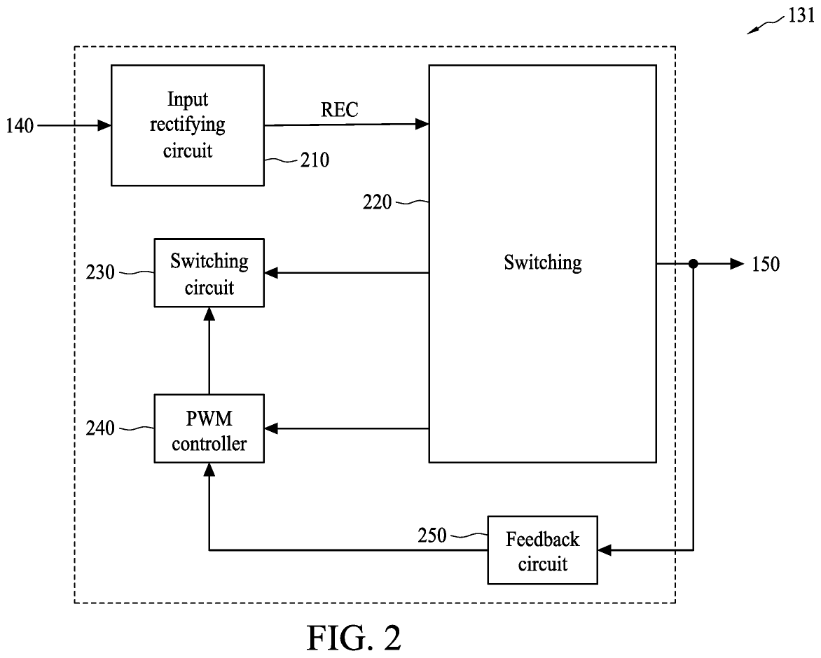

FIG. 2 is a diagram illustrating a transforming circuit 131 according to an embodiment of the present disclosure. As shown in FIG. 2, the transforming circuit 131 includes an input rectifying circuit 210, a transformer 220, a switching circuit 230, a PWM controller 240 and a feedback circuit 250. The input rectifying circuit 210 is arranged to generate a rectified signal REC according to the AC voltage 140, wherein the rectified signal REC is a DC signal. The transformer 220 receives the rectified signal REC at the primary side, and generates the DC voltage 150 at the secondary side according to the rectified signal REC. In one embodiment, the voltage level of the DC voltage 150 is smaller than that of the rectified signal REC. However, such embodiment is provided for illustrative purpose, and the disclosure is not limited to such embodiment. Therefore, the transformer 220 can be regarded as a DC-to-DC converter.

The switching circuit 230, the PWM controller 240 and the feedback circuit 250 are arranged to stabilize the DC voltage 150 at the secondary side of the transforming circuit 131. In some embodiments, the switching circuit 230 includes a driving transformer implemented by the model EE13. Said driving transformer receives a driving signal outputted by the PWM controller 240, and impels the transformer 220 to save or release energy according to the driving signal. In some embodiments, the PWM controller 240 is implemented by a PWM IC model NCP1252 manufactured by ON Semiconductor Corp, wherein the specification of NCP1252 can be found on the website (https://www.onsemi.com/pub/Collateral/NCP1252-D.PDF).

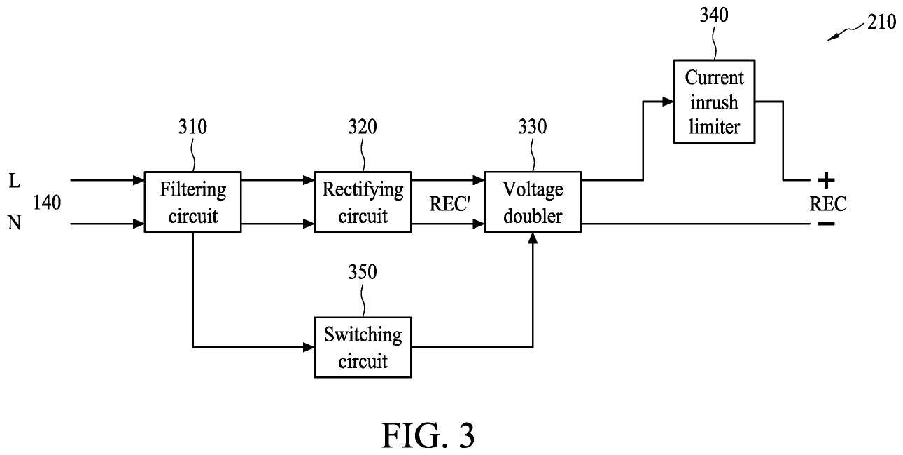

FIG. 3 is a diagram illustrating the input rectifying circuit 210 according to an embodiment of the present disclosure. As shown in FIG. 3, the input rectifying circuit 210 includes a filtering circuit 310, a rectifying circuit 320, a voltage doubler 330, a current inrush limiter 340, and a switching circuit 350. The AC voltage 140 is formed between a live wire L and a natural wire N in an electric outlet. The live wire L and the natural wire N are coupled to the filtering circuit 310.

In some embodiments, the input filter circuit 210 may further include a fuse and a hard switch connected between the live wire L and the filtering circuit 310. The filtering circuit 330 is arranged to reduce high frequency electronic noise, such as electromagnetic interference (EMI), which occurs as unwanted electrical signals and can be in the form of conducted or radiated emissions. In one embodiment, the filtering circuit 310 is implemented by an EMI filter model EE25. The rectifying circuit 320 is arranged to rectify the AC voltage 140 after the filtering circuit 310 to generate a rectified signal REC′. In one embodiment, the rectifying circuit 320 is implemented by a bridge rectifier. Those skilled in the art should readily understand the implementation of the bridge rectifier, and thus the detailed description is omitted here for brevity.

The switching circuit 350 and the voltage doubler 330 are arranged to double the voltage level of the rectified signal REC′. The current inrush limiter 340 is arranged to limit inrush current to avoid damage to components and avoid blowing fuses or tripping circuit breakers. It should be noted that the locations of the voltage doubler 330 and the current inrush limiter 340 are interchangeable.

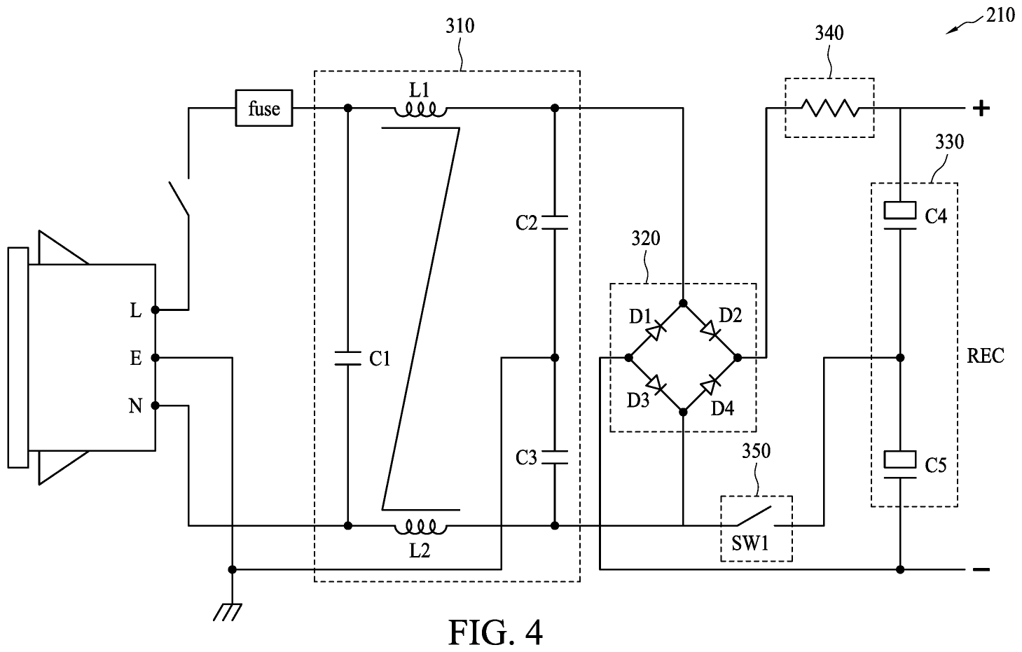

FIG. 4 is a diagram illustrating a detailed structure of the input rectifying circuit 210 according to an embodiment of the present disclosure. As shown in FIG. 4, the filtering circuit 310 includes inductors L1 and L2 and capacitors C1 to C3 to filter EMI as described above. The filtering circuit 310 is configured to as an Electromagnetic Compatibility (EMC)_π filter for filtering out the interference from the AC input. The rectifying circuit 320 includes diodes D1 to D4 connecting to form a bridge rectifier. The rectifying circuit 320 is configured to convert power from AC to DC. The voltage doubler 330 includes capacitors C4 and C5. The node connecting the capacitors C4 and C5 is further coupled to the earth wire E of an electric outlet via a switch SW1 of the switching circuit 350. The switching circuit 350 is configured to auto switch the input voltage from 110 volts to 220 volts. The current inrush limiter 340 includes a thermistor Rt to limit inrush current, wherein the current inrush limiter 340 is configured to protect the high current from the input. The functions of each circuit block are mentioned above, and thus the detailed description is omitted here for brevity.

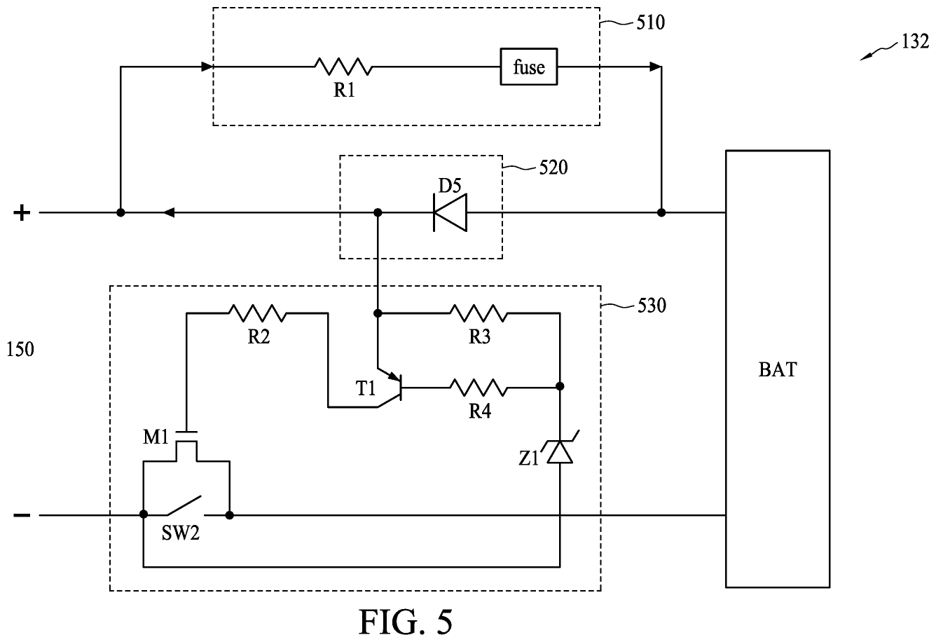

FIG. 5 is a diagram illustrating the control circuit 132 according to an embodiment of the present disclosure. As shown in FIG. 5, the control circuit 132 includes a charging circuit 510, a discharge circuit 520 and a discharge protecting circuit 530. The charging circuit 510 includes sources of impedance such as a resistor and a fuse. Therefore, the current generated from the DC voltage 150 passes through the charging circuit 510 to charge the battery BAT when the voltage level of the DC voltage 150 is greater than the voltage level of the battery BAT. The discharging circuit 520 includes a diode D5, which has a bias voltage. Therefore, the current generated by the battery BAT passes through the discharging circuit 520 when the voltage level of the battery BAT is greater than the sum of the voltage level of the DC voltage level 150 and the voltage level of the battery BAT. The discharge protecting circuit 530 includes a Metal-Oxide-Semiconductor Field-Effect Transistor (MOSFET) Ml, a Bipolar Junction Transistor (BJT) B1, resistors R2 to R4, a switch SW2 and a Zener diode Z1. The connection of the elements of the discharge protecting circuit 530 is shown in FIG. 5, and thus the detailed description is omitted here.

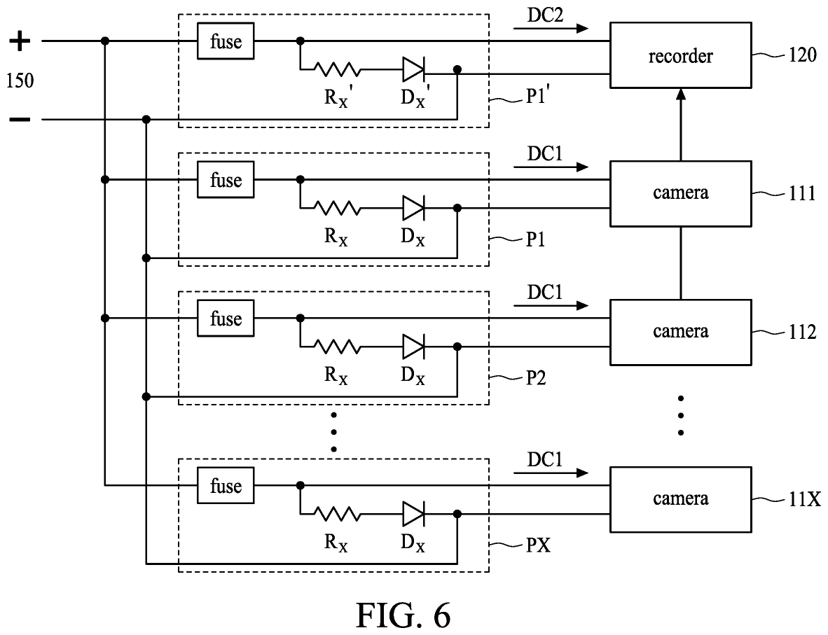

FIG. 6 is a diagram illustrating the structure of the output port P1′ and the output ports P1 to PX according to an embodiment of the present disclosure. The output port P1′ includes a fuse, a resistor Rₓ′ and a light-emitting diode (LED) Dₓ′, and each of the output ports P1 to PX includes a fuse, a resistor Rₓ and an LED D. By adjusting the impedance of the fuse and the resistor, the currents DC1 and DC2 can easily be adjusted.

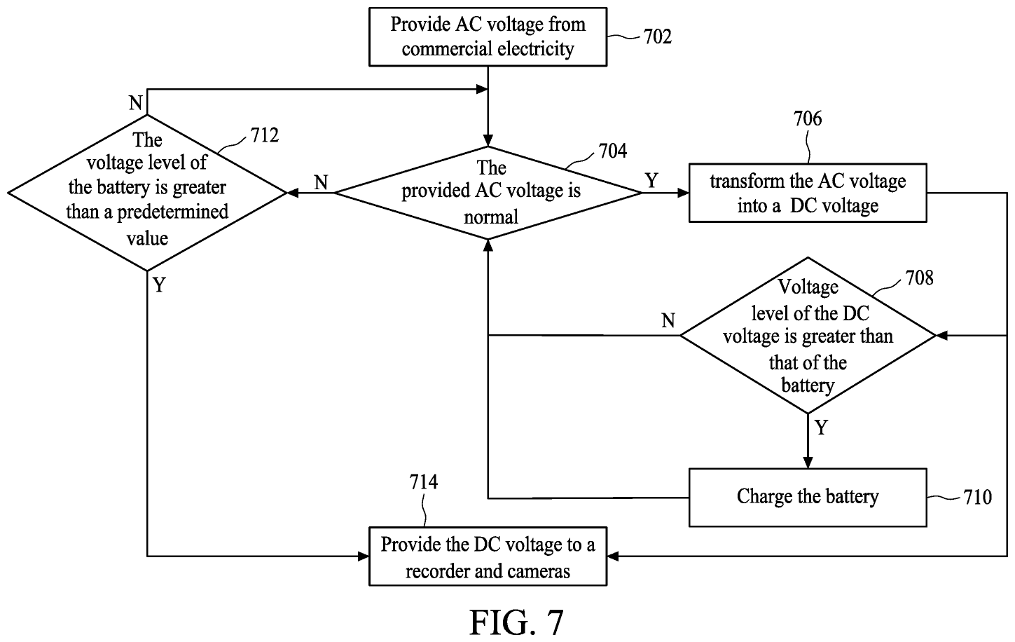

FIG. 7 is a flowchart illustrating a power supply method 700 of a CCTV system according to an embodiment of the present disclosure. As long as the results produced are substantially the same, the steps shown in FIG. 7 are not required to be executed in the exact order described, and other orders may be followed. The method 700 is summarized as follows.
Step 702: Receive an AC voltage from the electrical power grid.
Step 704: Determine whether the provided AC voltage is normal; if yes, go to step 706; otherwise, go to step 712.
Step 706: Convert the AC voltage into a DC voltage.
Step 708: Determine whether the voltage level of the DC voltage is greater than that of the battery; if yes, go to step 710; otherwise, go to step 704.
Step 710: Charge the battery.
Step 712: Determine whether the voltage level of the battery is greater than a predetermined value; if yes, go to step 714; otherwise, go to step 704.
Step 714: Provide the DC voltage to a recorder and cameras.

Those skilled in the art should readily understand the power supply method 700 after reading the descriptions above. Further detailed descriptions are omitted here for brevity.

What is claimed is:

1. A closed circuit television (CCTV) system, comprising:
a camera, arranged to capture an image;
a recorder, arranged to receive the image from the camera and store the image; and
a power supply circuit, including:
a transforming circuit, arranged to generate a direct current (DC) voltage by converting an alternating current (AC) voltage;
a first output port coupled to the camera;
a second output port coupled to the recorder;
a battery; and
a control circuit, arranged to selectively charge the battery with the DC voltage, and to selectively discharge the battery to provide a first DC current to the camera via the first output port and a second DC current to the recorder via the second output port.

2. The CCTV system of claim 1, wherein the control circuit discharges the battery to provide the first DC current and the second DC current when the voltage level of the battery is greater than a predetermined value.

3. The CCTV system of claim 1, wherein the control circuit charges the battery with the DC voltage when the DC voltage is greater than the voltage level of the voltage source.

4. The CCTV system of claim 1, wherein the transforming circuit includes:
an input rectifying circuit, arranged to generate a rectified signal according to the AC voltage; and
a transformer, arranged to generate the DC voltage according to the rectified signal.

5. A power supply circuit of a closed circuit television (CCTV) system, wherein the CCTV system includes a camera and a recorder, and the camera is arranged to capture an image and the recorder is arranged to receive the image from the camera and store the image, the power supply circuit comprising:
a transforming circuit, arranged to generate a direct current (DC) voltage by converting an alternating current (AC) voltage;
a first output port coupled to the camera;
a second output port coupled to the recorder; and
a control circuit, arranged to selectively charge a battery with the DC voltage, and selectively discharge the battery to provide a first DC current to the camera via the first output port and a second DC current to the recorder via the second output port.

6. The power supply circuit of claim 5, wherein the control circuit discharges the battery to provide the first DC current and the second DC current when the voltage level of the battery is greater than a predetermined value.

7. The power supply circuit of claim 5, wherein the control circuit charges the battery with the DC voltage when the DC voltage is greater than the voltage level of the voltage source.

8. The power supply circuit of claim 7, wherein the transforming circuit includes:
an input rectifying circuit, arranged to generate a rectified signal according to the AC voltage; and
a transformer, arranged to generate the DC voltage according to the rectified signal.

9. A power supplying method of a closed circuit television (CCTV) system, wherein the CCTV system includes a camera and a recorder, and the camera is arranged to capture an image and the recorder is arranged to receive the image from the camera and store the image, the method comprising:
selectively discharging a battery of the CCTV system to provide a first DC current to the camera and a second DC current to the recorder when a power supply from the electrical power grid provided to the CCTV system fails.

10. The method of claim 9, wherein selectively discharging the battery of the CCTV system to provide the first DC current to the camera and the second DC current when the power supply from the electrical power grid provided to the CCTV system fails comprises:
discharging the battery when a voltage level of the battery is greater than a predetermined voltage level.

11. The method of claim 9, further comprising:
selectively charging the battery when the power supply from the electrical power grid is provided to the CCTV system.

12. The method of claim 9, wherein selectively charging the battery when the power supply from the electrical power grid is provided to the CCTV system comprises:
converting the power supply into a DC voltage;
charging the battery with the DC voltage when a voltage level of the DC voltage is greater than a voltage level of the battery.
